(19) United States
(12) Patent Application Publication
(10) Pub. No.: US 2024/0162029 A1
(43) Pub. Date: May 16, 2024

(54) Bifurcated Mass Spectrometer

(71) Applicant: DH Technologies Development Pte. Ltd., Singapore (SG)

(72) Inventor: Eric Thomas DZIEKONSKI, Concord (CA)

(21) Appl. No.: 18/280,542

(22) PCT Filed: Mar. 4, 2022
(86) PCT No.: PCT/IB2022/051952

§ 371 Date: Sep. 6, 2023

Related U.S. Application Data
(60) Provisional application No. 63/157,964, filed on Mar. 8, 2021.

(51) Int. Cl. H01J 49/42; H01J 49/00; H01J 49/06; H01J 49/22; H01J 49/40

(52) U.S. Cl. CPC H01J 49/427; H01J 49/0072; H01J 49/063; H01J 49/22; H01J 49/40; H01J 49/4215

(57) ABSTRACT

A mass spectrometer includes at least one ion guide having an inlet for receiving a plurality of ions from an upstream ion source and an outlet through which ions exit the ion guide, an ion routing device having an inlet for receiving at least a portion of the ions exiting the ion guide and at least two outlets, a first mass spectrometer positioned relative to the first outlet to receive ions exiting the ion routing device via the first outlet, and a second mass spectrometer positioned relative to the second outlet to receive ions exiting the ion routing device via the second outlet.

### RELATED APPLICATIONS

This application claims priority to U.S. Provisional Application No. 63/157,964 filed on Mar. 8, 2021, entitled “Bifurcated Mass Spectrometer,” the contents of which are incorporated herein in their entirety.

### BACKGROUND

The present disclosure is generally directed to a mass spectrometer as well as methods for performing mass spectrometry, e.g., mass spectrometers that can provide a bifurcated ion path along each of which a mass spectrometer can be positioned.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

A variety of mass analyzers can be employed in a mass spectrometer for providing mass analysis of precursor and/or product ions generated via fragmentation of precursor ions. Some examples of such mass analyzers include a time-of-flight mass analyzer a quadrupole mass analyzer, among others. Each mass analyzer can provide certain advantages and shortcomings. For example, time-of-flight and quadrupole mass analyzers can differ in their resolution, cost, speed, duty cycle, transmission efficiency, etc. It is possible to use different mass spectrometers having different mass analyzers (e.g., a time-of-flight mass spectrometer and a quadrupole mass spectrometer) to analyze different portions of a sample to augment the information obtained via one mass analyzer with that obtained via another mass analyzer.

The above approach suffers, however, from a number of shortcomings. For example, such an approach can be time consuming, and it requires ownership of multiple mass spectrometers.

Accordingly, there is a need for enhanced mass spectrometers and methods of mass spectrometry

### SUMMARY

In one aspect, a mass spectrometer is disclosed, which comprises at least one ion guide having an inlet for receiving a plurality of ions from an upstream ion source and an outlet through which ions exit the ion guide, and an ion routing device having an inlet for receiving at least a portion of the ions exiting the ion guide and at least two outlets through which ions can exit the ion routing device. A first mass spectrometer is positioned relative to the first outlet to receive ions exiting the ion routing device via the first outlet, and a second mass spectrometer is positioned relative to the second outlet to receive ions exiting the ion routing device via the second outlet.

In some embodiments, the mass spectrometer can include a controller operably coupled to the ion routing device for controlling distribution of ions received via the inlet of the ion routing device between the two outlets. The controller can be configured to apply one or more control signals to the ion routing device such that the ions received via the inlet of the ion routing device are directed to each of said outlets during a different temporal interval. For example, the controller can be configured to apply one or more control signals to direct ions received via the inlet of the ion receiving device to its outlets during alternating temporal intervals.

In some embodiments, the controller is configured to apply one or more control signals to the ion routing device for substantially concurrently directing a portion of the received ions to one of said outlets and another portion of the received ions to the other outlet.

In some embodiments, the first and second mass spectrometers include different mass analyzers. By way of example, in some such embodiments, one of the mass analyzers can be a quadrupole mass analyzer and the other mass analyzer can be a time-of-flight mass analyzer.

The ion routing device can be implemented in a variety of different ways. By way of example, in some embodiments, the ion routing device can have a branched quadrupole structure. In other embodiments, the ion routing device can include an electrostatic deflector. In some such embodiments, the mass spectrometer can include a DC voltage source for applying a DC voltage to the electrostatic deflector for causing at least a portion of the ions received by the ion routing device to be directed to one of its outlets. For example, the controller can be configured to apply control signals to the DC voltage source such that the DC voltage source applies one or more voltage pulses to the electrostatic deflector for directing the received ions into the two outlets of the ion routing device during different time intervals.

In some embodiments, at least one of the first and second mass spectrometers includes a mass filter that is positioned downstream of the outlet of the ion routing device associated with that mass spectrometer for selecting precursor ions having m/z ratios within a desired range from among ions exiting through the outlet of the ion routing device In some embodiments, a collision cell is positioned downstream of the mass filter for causing fragmentation of at least a portion of the precursor ions so as to generate a plurality of product ions. In some such embodiments, the collision cell can include a plurality of rods arranged in a multipole configuration, e.g., in a quadrupole configuration, and configured for application of RF and/or DC voltages thereto for providing radial confinement of the precursor ions. A mass analyzer can be disposed downstream of the collision cell for receiving at least a portion of the product ions and providing a mass analysis thereof. In principle, any mass analyzer can be employed. For example, and without limitation, the mass analyzer can be any of a quadrupole mass analyzer, a time-of-flight mass analyzer, an electrostatic orbital trap, an electrostatic linear ion trap, FT-ICR, MR-TOF, toroidal ion traps, among others.

In some embodiments, the mass filter includes a plurality of rods arranged in a multipole configuration, e.g., a quadrupole configuration, and configured for application of an RF and/or DC voltage thereto for generating an electromagnetic field for facilitating selection for the ions having m/z ratios within said desired range.

Since two or more mass spectrometers with different mass analyzers can be used in a single system, the footprint of the instrument can be made smaller, the ownership cost can be reduced, and instrument variability between platforms can be minimized.

Further understanding of various aspects of the present teachings can be obtained by reference to the following detailed description in conjunction with the associated drawings, which are discussed briefly below.

### BRIEF DESCRIPTION OF THE DRAWINGS

FIG. 1 schematically depicts a mass spectrometer according to an embodiment of the present teachings;

FIG. 2 schematically depicts an example of an implementation of the mass spectrometer shown in FIG. 1;

FIG. 3A schematically depicts an example of an ion routing device suitable for use in a mass spectrometer according to the present teachings;

FIG. 3B schematically depicts the DC voltage source alternatingly activating and deactivating the electrode in regular time intervals;

FIG. 4A schematically depicts another example of an ion routing device suitable for use in a mass spectrometer according to the present teachings;

FIGS. 4B-4E schematically depict the ions being routed to a plurality of outlets based on different configurations of the DC voltage application to each electrode;

FIG. 5 is a schematic view of a mass spectrometer according to an embodiment of the present teachings in which one of the ion paths leading from an outlet of an ion routing device to a detector is curved;

FIG. 6 is a schematic view of an example of an implementation of the mass spectrometer depicted in FIG. 5 in which a laser beam is employed for causing photodissociation of a plurality of precursor ions, and

FIG. 7 schematically depicts an example of an implementation of a controller according to an embodiment of the present teachings.

### DETAILED DESCRIPTION

The present teachings are generally directed to mass spectrometers and associated methods of performing mass spectrometry in which an ion routing device (herein also referred to as a bifurcation device) is employed for directing ions into two ion paths in each of which a mass spectrometer unit having a mass analyzer is incorporated. In some embodiments, one path directs the ions to a quadrupole mass analyzer and the other ion path directs the ions to a time-of-flight mass analyzer.

Various terms are used herein in accordance with their ordinary meanings in the art. The term “about” as used herein is intended to indicate a variation around a numerical value of at most 10%. The term “substantially” as used herein refers to a condition or state that may deviate from a complete state or condition by at most 10%.

Although examples of embodiments described herein can include a plurality of modules for implementing aspects of present teachings, it is understood that various aspects of the present teachings may also be performed by one or a plurality of modules. Additionally, it is understood that the term controller/control unit refers to a module that can be implemented in hardware/firmware/software or combination thereof. In some embodiments, the controller can include a processor, memory and one or more communication buses for providing communication among its various components. For example, instructions for performing various methods disclosed herein, such as analysis of ion detection signals for generating a mass spectrum, can be stored in one or more memory modules and be used during runtime by the processor to implement the method.

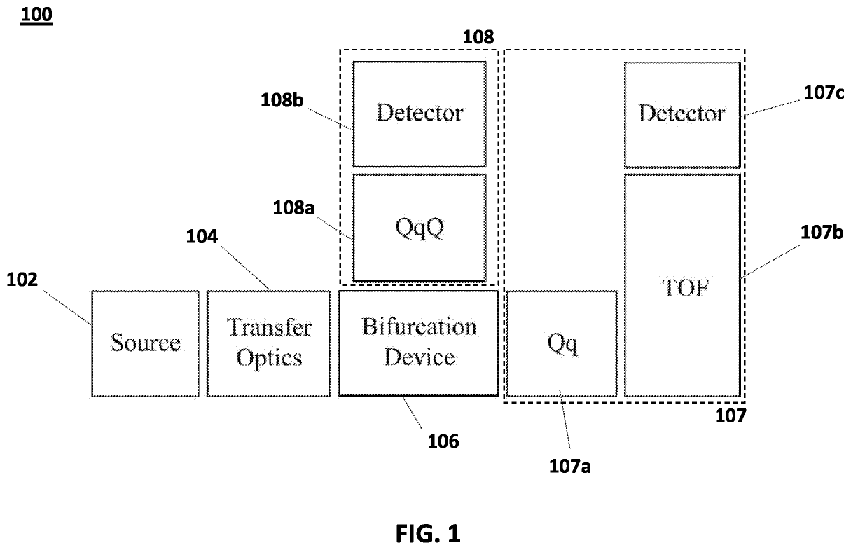

FIG. 1 schematically depicts a mass spectrometer 100 according to an embodiment of the present teachings, which includes an ion source 102 for generating a plurality of ions and one or more transfer ion optics 104 for transmission of ions generated by the ion source to an ion routing device 106 (a bifurcation device). By way of example, the transfer ion optics 104 can include one or more ion guides, ion lenses, etc.

The ion routing device 106 receives ions from the transfer ion optics 104 and distributes the received ions between at least two outlets, one of which is connected to a mass spectrometer 107 having a time-of-flight (TOF) mass analyzer and another is connected to another mass spectrometer 108 having a quadrupole mass analyzer. The mass spectrometer 107 includes a mass filter for selecting at least a portion of the received ions having m/z ratios in a desired range and a downstream collision cell that receives the selected ions (herein also referred to as precursor ions) and causes fragmentation of at least a portion thereof to generate a plurality of product ions. One or more ion optics, such as ion lenses, can be employed to focus and direct the ions, e.g., as they are introduced into the mass filter and/or the collision cell, e.g., as discussed below (the mass filter, the collision cell and the associated ion optics are herein collectively referred to as Qq 107a). A time-of-flight mass analyzer 107b and an ion detector 107c disposed downstream of the time-of-flight mass analyzer 107b receive the product ions and cooperatively provide a mass spectrum of the product ions.

The mass spectrometer 108 includes a mass filter (e.g., a quadrupole mass filter) for selecting at least a portion of ions received via the other outlet of the ion routing device 106, a collision cell for causing fragmentation of at least a portion of the ions selected by the mass filter (herein also referred to as precursor ions) to generate a plurality of product ions. A quadrupole mass analyzer can receive the product ions and allow mass analysis thereof in a manner known in the art (the mass filter, the collision cell, and the downstream mass analyzer are collectively referred to herein as QqQ 108a). An ion detector 108b can receive the ions exiting the quadrupole mass analyzer for generating mass detection signals, which can be employed to generate a mass spectrum of the product ions.

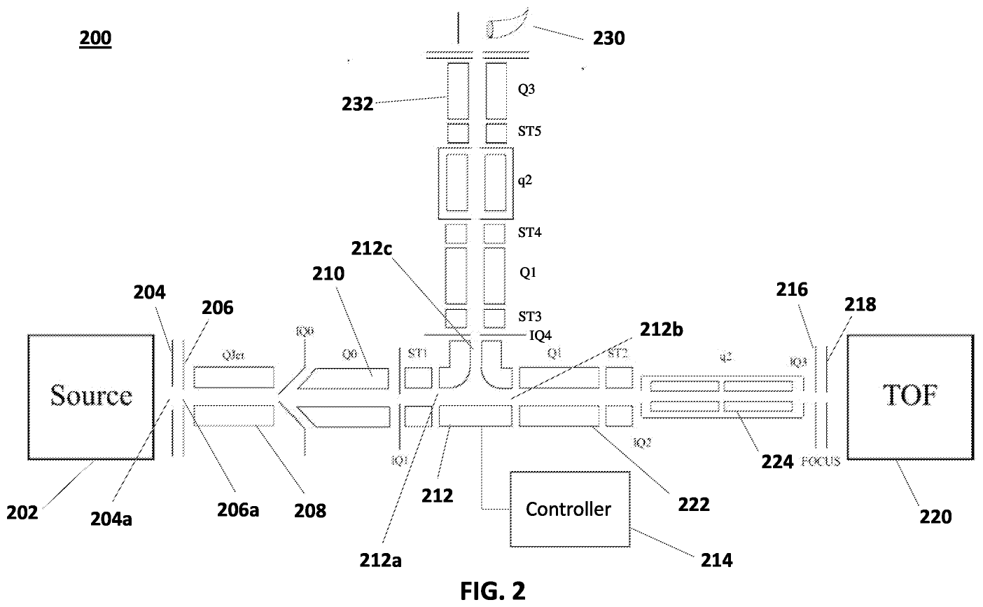

FIG. 2 schematically depicts an example of an implementation of the mass spectrometer 100 (this implementation is herein referred to as mass spectrometer 200), which includes an ion source 202 for generating a plurality of ions. A variety of ion sources can be employed in the practice of the present teachings. Some examples of suitable ion sources include, without limitation, a MALDI (matrix-assisted laser desorption/ionization), ESI (electro spray ion source), nano-ESI, APCI (atmospheric pressure chemical ionization) ion sources.

The generated ions pass through an orifice 204a of a curtain plate 204 and an orifice 206a of a orifice plate 206, which is positioned downstream of the curtain plate 204 and is separated from the curtain plate 204 such that a gas curtain chamber is formed between the orifice 206a and the curtain plate 204. A curtain gas supply (not shown) can provide a curtain gas flow (e.g., of nitrogen) between the curtain plate 204 and the orifice plate 206 to help keep the downstream section of the mass spectrometer clean by declustering and evacuating large neutral particles. The curtain chamber can be maintained at an elevated pressure (e.g., a pressure greater than the atmospheric pressure) while the downstream sections of the mass spectrometer can be maintained at one or more selected pressures by evacuation through one or more vacuum pumps (not shown).

In this embodiment, the ions passing through the orifices 204a and 206a of the curtain plate and the orifice plate are received by an ion optic Qjet, which comprises four rods 208 (two of which are visible in FIG. 2) that are arranged in a quadrupole configuration to form an ion beam for transmission to downstream components of the mass spectrometer. In use, the ion optic Qjet can be employed to capture and focus the ions received through the opening of the curtain plate 204 using a combination of gas dynamics and radio frequency fields.

The ion beam exits the Qjet ion optic and is focused via a lens IQ0 into a subsequent ion guide Q0, which includes four rods 210 (two of which are visible in FIG. 2) that are arranged in a quadrupole configuration and to which RF and/or DC voltages can be applied for focusing the ions as they pass through the ion guide Q0. In other embodiments, other multipole configurations, such as a hexapole or an octupole configuration, can be utilized. In some embodiments, the pressure of the ion guide Q0 can be maintained, for example, in a range of about 1 mTorr to about 25 mTorr, e.g., about 10 mTorr.

The ion guide Q0 delivers the ions to an ion routing device 212 via an ion lens IQ1, and a stubby lens ST1, which functions as a Brubaker lens, according to an embodiment of the present teachings. The ion routing device 212 includes an inlet 212a through which the ions exiting the ion guide Q0 enter the ion routing device 212, a first outlet 212b and a second outlet 212c through which the ions can exit the ion routing device 212.

In this embodiment, a controller 214 is operably coupled to the ion routing device 212 to apply one or more control signals to the ion routing device 212 to distribute the ions received via the inlet 212a between the first outlet 212b and the second outlet 212c according to a predefined protocol, such as those discussed below.

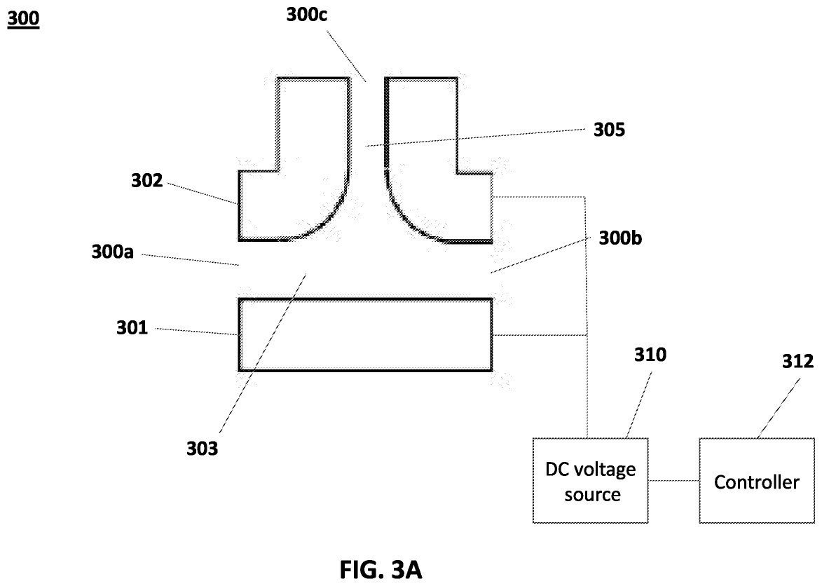

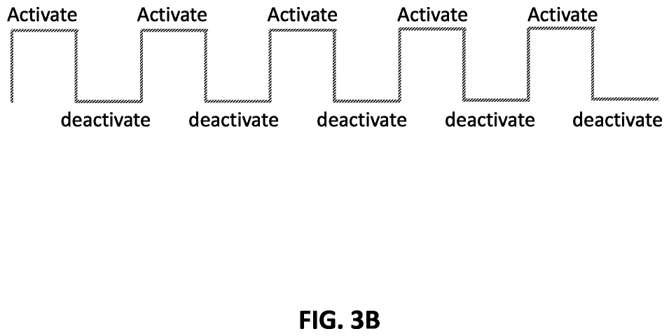

The ion routing device 212 can be implemented in a variety of different ways. In this embodiment, the ion routing device 212 is implemented as an electrostatic deflector. As shown schematically in FIG. 3A, the electrostatic deflector 300 can include a first electrode 301 and a second electrode 302 that are positioned opposing each other to provide a first passageway 303 therebetween, the first passageway 303 extending from an inlet 300a of the electrostatic deflector 300 to a first outlet 300b. The second electrode 302 includes an opening that provides a second passageway 305 through which ions can exit the electrostatic deflector 300 via a second outlet 300c thereof upon activation of the first electrode 301. For example, a voltage source 310 is electrically connected to the first electrode 301 to apply voltage pulses thereto so as to activate the first electrode 301 according to a predefined protocol, e.g., in selected time intervals, for deflecting the ions received via the inlet 300a of the electrostatic deflector 300 into the second passageway 305 through which the deflected ions can exit the electrostatic deflector 300 via the second outlet 300c. In this embodiment, the DC voltage source 310 operates under the control of a controller 312 that is configured to apply control signals to the DC voltage source 310 for applying voltage pulses to the first electrode 301 of the electrostatic deflector 300.

For example, in some embodiments, the controller 312 is configured to apply control signals to the DC voltage source 310 such that the DC voltage source applies DC voltage pulses to the first electrode 301 so as to alternatingly activate and deactivate the first electrode 301 in regular time intervals as shown schematically in FIG. 3B. Further, in some embodiments, in addition to activating the electrode 301, an attractive voltage can be applied to the electrode 302 (e.g., a negative voltage when the ions are positively charged) so as to help guide the ions toward toward the exit port 300c.

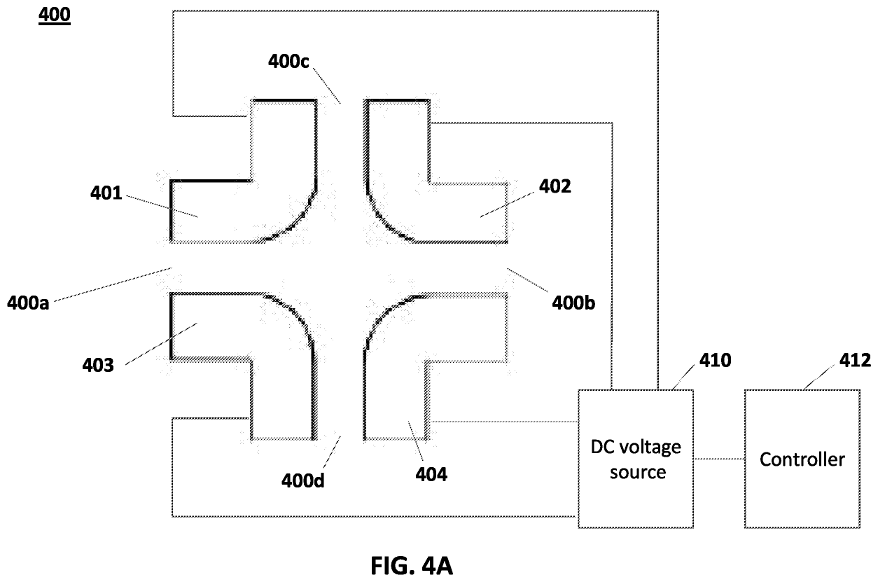

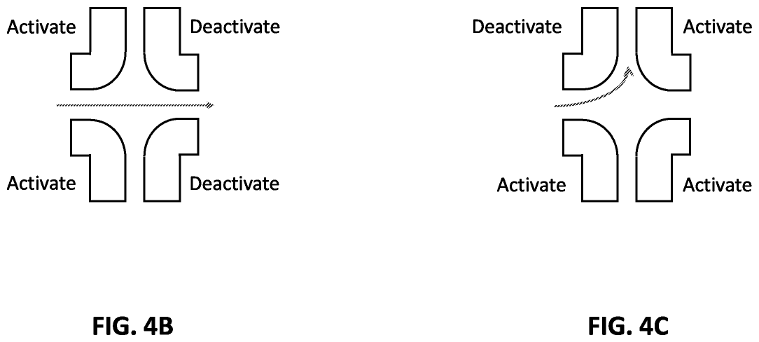

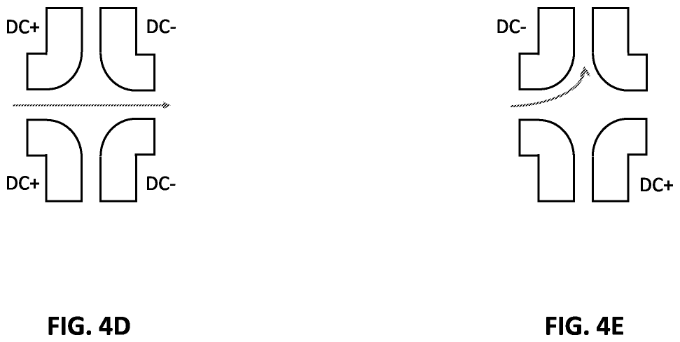

FIG. 4A schematically depicts another example of an implementation of the ion routing device 212, which has a branched quadrupole structure. As shown schematically in FIG. 4A, the branched quadrupole structure 400 can include a first electrode 401, a second electrode 402, a third electrode 403, and a fourth electrode 404. The first electrode 401 and the second electrode 402 are positioned opposing the third electrode 403 and the fourth electrode 404 while the first electrode 401 and the fourth electrode 404 diagonally face each other, and the second electrode 402 and the third electrode 403 diagonally face each other, as shown in FIG. 4A. An inlet 400a is formed between the first electrode 401 and the third electrode 403, a first outlet 400b is formed between the second electrode 402 and the fourth electrode 404, and a second outlet 400c is formed between the first electrode 401 and the second electrode 402. Further a third outlet 400d is formed between the third electrode 403 and the fourth electrode 404. Each electrode is electrically connected to a voltage source 410, which operates under the control of a controller 412. The controller 412 is configured to apply control signals to the voltage source 410 to direct or steer the ions entering the branched quadrupole structure 400 through the inlet 400a to exit through one of the first outlet 400b, the second outlet 400c, or the third outlet 400d.

For example, in operation, in order to direct positively charged ions toward the first outlet 400b, the controller 412 can activate the first electrode 401 and the third electrode 403, and deactivate the second electrode 402 and the fourth electrode 404 as shown in FIG. 4B. In this embodiment, in order to direct positive ions towards the first outlet 400b, the electrodes 402 and 404 can be held at a lower electric potential than the electrodes 401 and 403. Further, in order to direct positive ions towards the second outlet 400c, the electrode 401 can be held at a more attractive potential than electrodes 402 and 403 while the electrode 404 is held at a more repulsive electric potential than the electrodes 402 and 403.

In some embodiments, in order to direct positively charged ions toward the first outlet 400b, the controller 412 can apply a positive DC voltage to the first electrode 401 and the third electrode 403, and apply a negative DC voltage to the second electrode 402 and the fourth electrode 404 as shown in FIG. 4D. In order to direct positively charged ions toward the second outlet 400c, the controller 412 can apply a positive DC voltage to the fourth electrode 404 relative to the potentials applied to the electrodes 402 and 403, and a negative DC voltage to the first electrode 401 relative to the potentials applied to the electrodes 402 and 403 as shown in FIG. 4E.

The controller 412 can be configured to apply one or more control signals to the ion routing device 400 such that the ions received via the inlet 400a of the ion routing device 400 are directed to each of the first outlet 400b, the second outlet 400c, and the third outlet 400d during a different temporal interval. For example, the controller 412 can be configured to apply one or more control signals to direct the ions to the first outlet 400b, the second outlet 400c, and the third outlet 400d during alternating temporal intervals. In some embodiments, the controller 412 may be configured to apply one or more control signals to the ion routing device 400 for substantially concurrently directing a portion of the received ions to one of the outlets and another portion of the received ions to another one of the outlets.

With reference to FIGS. 1 and 2 again, in this embodiment, the mass spectrometer 107 includes a time-of-flight mass analyzer 107b and the mass spectrometer 108 includes a quadrupole mass analyzer 108a.

More specifically, the mass spectrometer 107 receives the ions exiting the first outlet 212b of the ion-routing device 212 into a downstream ion guide Q1, which is configured to function as a mass filter. In this embodiment, the ion guide Q1 includes four rods 222 that are arranged in a quadrupole configuration (though in other embodiments, other multipole configurations can also be employed) and to which RF and/or DC voltages can be applied. In some embodiments, the ion guide Q1 can be situated in a vacuum chamber that can be maintained, for example, at a pressure in a range of about 1E-16 to about 1E-4 Torr.

As noted above, in this embodiment, the ion guide Q1 is configured as a quadrupole rod set and can be operated as a conventional transmission RF/DC quadrupole mass filter for selecting an ion of interest and/or a range of ions of interest. By way of example, the ion guide Q1 can be provided with RF/DC voltages, via RF and/or DC voltage sources, suitable for operation in a mass-resolving mode. For example, parameters of applied RF and DC voltages can be selected so that the ion guide Q1 establishes a transmission window of chosen m/z ratios, such that these ions can traverse the ion guide Q1 largely unperturbed. Ions having m/z ratios falling outside the transmission window, however, do not attain stable trajectories within the quadrupole rod set and can be prevented from traversing the ion guide Q1. It should be appreciated that this mode of operation is but one possible mode of operation for the ion guide Q1.

In this embodiment, the ions selected by the ion guide Q1 are focused via a stubby lens ST2 into a collision cell q2. In this embodiment, the collision cell q2 includes an inlet lens IQ2 and a pressurized compartment that can be maintained, e.g., at a pressure in a range of about 1 mTorr to about 10 mTorr, although other pressures can also be used for this or other purposes. A suitable collision gas (e.g., nitrogen, argon, helium, etc.) can be provided by way of a gas inlet (not shown) to fragment at least a portion of the ions received by the collision cell q2. In this embodiment, the collision cell q2 includes four rods 224 that are arranged in a quadrupole configuration and to which RF and/or DC voltages can be applied (via one or more RF and/or DC voltage sources not shown in this figure) for generating an electromagnetic field that can provide radial confinement of the precursor and product ions.

The product ions exit the collision cell q2 via an exit port of the collision cell q2 and are focused by an exit lens IQ3 and a pair of ion lenses 216 and 218 into a time-of-flight mass analyzer 220. The time-of-flight mass analyzer 220 provides a mass spectrum of the product ions in a manner known in the art.

With continued reference to FIGS. 1 and 2, the ions that exit the ion routing device 212 via the second outlet 212c are received by another mass filter Q1 via an ion lens IQ4 and a stubby lens ST3, which provide focusing of the ions. Similar to the mass filter Q1 discussed above, the mass filter Q1 can function in a mass-resolving mode to establish a transmission window of chosen m/z ratios, such that these ions can traverse Q1 largely unperturbed.

Again, similar to the mass spectrometer 107, the mass spectrometer 108 includes another collision cell q2 that is positioned downstream of the mass filter Q1, which receives the ions selected by the mass filter Q1 via a stubby lens ST4. The collision cell q2 functions in a similar manner as the above collision cell q2 discussed above to fragment at least a portion of the ions received from the upstream mass filter to generate a plurality of product ions.

The product ions generated by the collision cell q2 are received by a downstream quadrupole mass analyzer Q3 via a stubby lens ST5, which functions to focus the products ion into the quadrupole mass analyzer Q3. The quadrupole mass analyzer Q3 includes four rods 232 that are arranged relative to one another in a quadrupole configuration and to which RF and/or DC voltages can be applied in a manner known in the art to provide mass analysis of the product ions. If acting as a mass filter, the RF and DC voltages can be ramped concurrently to generate a mass spectrum. If acting as an ion trap (no isolation), the RF voltage is ramped to scan ions out of the trap and generate a mass spectrum.

In some embodiments, at least one of the mass spectrometers 107 and 108 that is coupled to the ion routing device 212 can provide a curved ion path from its inlet to its detector. Such a curved ion path can provide certain advantages. For example, it can reduce the instrument's height, the size of the electronic enclosure, and/or allow for ultraviolet (UV) photodissociation of at least a portion of the product ions in proximity of a collision cell's exit, as discussed in more detail below.

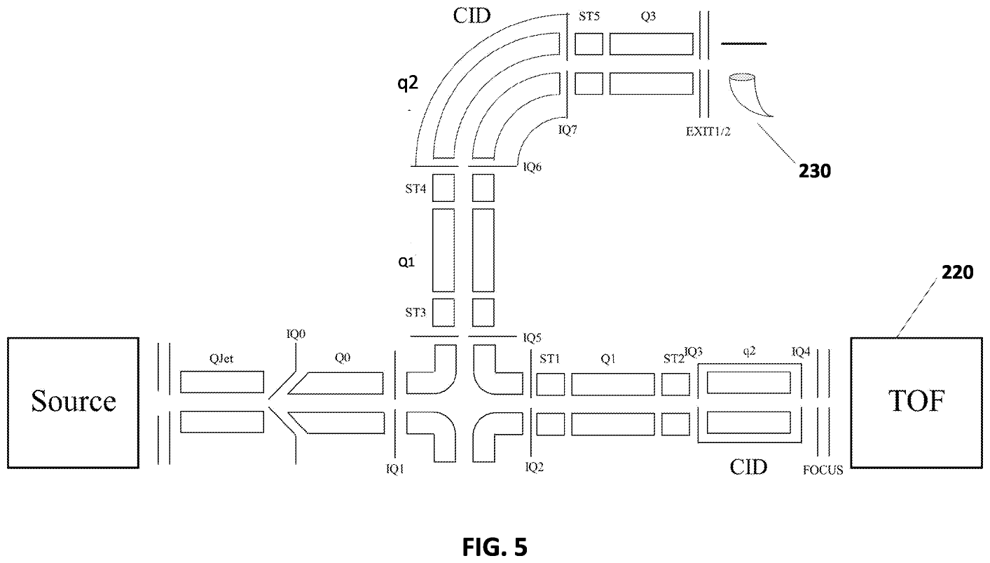

By way of example, FIG. 5 is a schematic view of a mass spectrometer according to an embodiment of the present teachings in which a mass spectrometer 108 in which a quadrupole mass analyzer 108a is employed for mass analysis is configured to provide a curved ion path. As described above, the mass spectrometer 108 includes a mass filter Q1 that receives ions via the ion lens IQ5 and the stubby lens ST3. In this embodiment, however, a collision cell q2 disposed downstream of the mass filter Q1 includes four curved rods that extend from an inlet of the collision cell q2 to its outlet and are arranged according to a quadrupole configuration.

In this embodiment, the collision cell q2 is pressurized with a gas (e.g., nitrogen, argon, etc.) to cause fragmentation of at least a portion of ions received from the upstream mass filter Q1. The product ions are then received by a downstream mass analyzer Q3 via a stubby lens ST5 and a downstream ion detector 230 that detects ions exiting the mass analyzer Q3. Due to the curved collision cell q2, the mass spectrometer including the ion detector 230 can be placed adjacent to and/or parallel to the time-of-flight mass analyzer 220, thereby allowing the mass spectrometer system to become more compact.

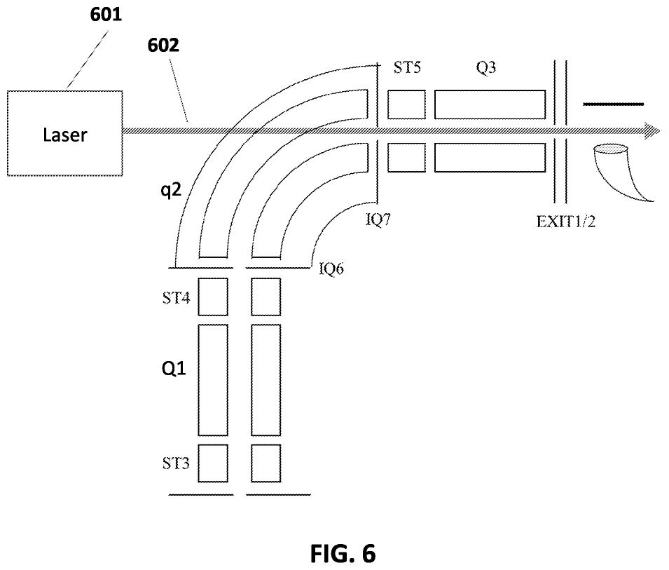

FIG. 6 shows another embodiment of a quadrupole mass spectrometer 108, which has the same structure as that discussed above in connection with the spectrometer depicted in FIG. 5. However, in this mass spectrometer, rather than employing pressurized gas to cause ion fragmentation, a laser beam 602 (e.g., a UV laser beam), generated by a laser 601 is directed into the collision cell q2, e.g., in proximity of its outlet, to cause photodissociation of at least a portion of the ions received by the collision cell q2. In some embodiments, the laser can be mounted onto the collision cell chamber and be pulsed when ions are in the activation zone (e.g., exit of q2, IQ7, ST5, or Q3). In some embodiments, the laser radiation can be introduced into collision cell q2 via a window, which can be positioned, e.g., (1) between the laser and q2 to introduce the beam into the mass spectrometer, (2) on the enclosure of q2 to allow the beam to enter q2. Further, a window can be positioned after the detector to allow the beam to exit the mass spectrometer chamber. In such embodiments, the two windows can be aligned with the exit hole aperture of the IQ7.

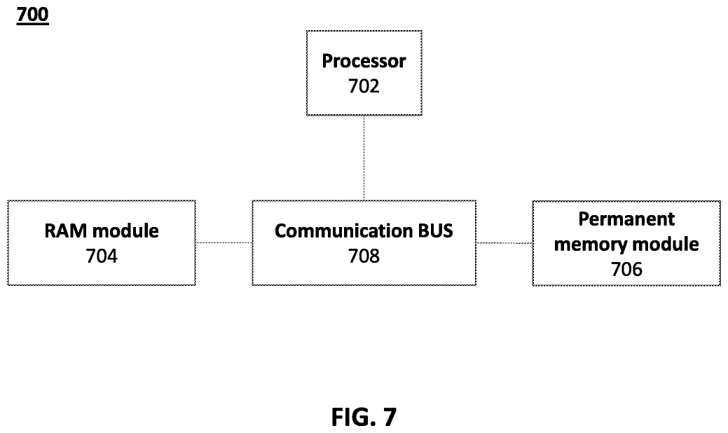

As noted above, a controller employed for practicing various aspects of the present teachings as discussed above can be implemented in hardware/firmware/software or combination thereof. By way of example, FIG. 7 schematically depicts an example of an implementation of a controller 700, which includes a processor 702, a random access memory (RAM) module 704, a permanent memory module 706, and a communication bus 708 that allows the processor 702 to communicate with other components of the controller 700. In some embodiments, various instructions for performing different functions of the controller 700, e.g., activating and deactivating an electrostatic deflector and/or analyzing detection signals generated by an ion detector, can be stored in the permanent memory module 706 and can be transferred to the RAM module 704 during runtime by the processor 702, which can execute those instructions for performing the respective functions.

What is claimed is:

1. A mass spectrometer, comprising:
at least one ion guide having an inlet for receiving a plurality of ions from an upstream ion source and an outlet through which ions exit the ion guide,
an ion routing device having an inlet for receiving at least a portion of the ions exiting the ion guide and at least two outlets,
a first mass spectrometer positioned relative to the first outlet to receive ions exiting the ion routing device via the first outlet, and
a second mass spectrometer positioned relative to the second outlet to receive ions exiting the ion routing device via the second outlet.

2. The mass spectrometer of claim 1, further comprising a controller operably coupled to said ion routing device for controlling distribution of ions received via said inlet of the ion routing device between said two outlets.

3. The mass spectrometer of claim 1, wherein the controller is configured to apply one or more control signals to said ion routing device such that the ions received via said inlet of the ion routing device are directed to each of said outlets during a different temporal interval.

4. The mass spectrometer of claim 3, wherein said controller is configured to apply one or more control signals to direct ions received via said inlet of the ion receiving device to said outlets during alternating temporal intervals.

5. The mass spectrometer of claim 2, wherein said controller is configured to apply one or more control signals to said ion routing device for substantially concurrently directing a portion of the received ions to one of said outlets and another portion of the received ions to the other outlet.

6. The mass spectrometer of claim 1, wherein said first and second mass spectrometers comprise different types of mass analyzers.

7. The mass spectrometer of claim 1, wherein said first and second mass spectrometers comprise the same type of mass analyzer.

8. The mass spectrometer of claim 1, wherein at least one of said first and second mass spectrometers comprises a quadrupole mass analyzer and the other mass spectrometer comprises a time-of-flight mass analyzer.

9. The mass spectrometer of claim 1, wherein said ion routing device comprises a branched quadrupole structure.

10. The mass spectrometer of claim 1, wherein said ion routing device comprises an electrostatic deflector.

11. The mass spectrometer of claim 10, further comprising a DC voltage source for applying a DC voltage to said electrostatic deflector for causing at least a portion of the received ions to be directed to at least one of said two outlets.

12. The mass spectrometer of claim 11, wherein said controller is configured to apply control signals to said DC voltage source such that the DC voltage source applies one or more voltages to said electrostatic deflector for directing the received ions into said two outlets during different time intervals.

13. The mass spectrometer of claim 1, wherein at least one of said first and second mass spectrometers comprises a mass filter positioned downstream of the outlet of the ion routing device associated with said at least one mass spectrometer for selecting precursor ions having m/z ratios within a desired range from among ions exiting through said outlet.

14. The mass spectrometer of claim 13, further comprising a collision cell positioned downstream of said mass filter for causing fragmentation of at least a portion of said precursor ions so as to generate a plurality of product ions.

15. The mass spectrometer of claim 14, wherein said collision cell comprises a plurality of rods arranged in a multipole configuration and configured for application of RF and/or DC voltages thereto for providing radial confinement of said precursor ions.

16. The mass spectrometer of claim 14, further comprising a mass analyzer disposed downstream of said collision cell for receiving at least a portion of said plurality of product ions and providing a mass analysis thereof.

17. The mass spectrometer of claim 16, wherein said mass analyzer comprises a quadrupole mass analyzer.

18. The mass spectrometer of claim 16, wherein said mass analyzer comprises a time-of-flight mass analyzer.

19. The mass spectrometer of claim 13, wherein said mass filter comprises a plurality of rods arranged in a multipole configuration and configured for application of an RF and/or DC voltage thereto for generating an electromagnetic field for facilitating selection for the ions having m/z ratios within said desired range.

20. The mass spectrometer of claim 19, wherein said multipole configuration comprises a quadrupole configuration.
